(19) United States
(12) Patent Application Publication
(10) Pub. No.: US 2021/0089103 A1
(43) Pub. Date: Mar. 25, 2021

(54) CHANGING POWER STATES

(71) Applicant: Hewlett-Packard Development Company, L.P., Spring, TX (US)

(72) Inventors: Poying Chih, Taipei City (TW); Tan Lin, Taipei City (TW); Raymond Liu, Taipei City (TW); ChenTai Huang, Taipei City (TW)

(73) Assignee: Hewlett-Packard Development Company, L.P., Spring, TX (US)

(21) Appl. No.: 16/954,787

(22) PCT Filed: Jan. 31, 2018
(86) PCT No.: PCT/US2018/016311

§ 371 Date: Jun. 17, 2020

(51) Int. Cl. G06F 1/32; G06F 9/4401; G06F 13/42

(52) U.S. Cl. CPC G06F 1/32; G06F 9/4406; G06F 2213/0042; G06F 9/4418; G06F 13/4282

(57) ABSTRACT

Examples disclosed herein relate to changing power states of a device. Example devices include an input/output port to couple to a component to receive an actuation event. A chipset processor of the device may determine a power state of the device; in response to a determination that the power state is an ultra-low power state, determine a component identification (ID) of the component; fetch a reference ID from non-volatile memory; and compare the determined component ID with the reference ID. The chipset processor of the example device to transmit a signal to change the power state of the device in response to a match between the determined component ID and the reference ID and reception of signals indicative of an actuation event.

### BACKGROUND

Devices using operating systems are increasingly popular and more and more electronic devices are being provided with operating systems. Devices using operating systems are not accessible to a user for normal operation until the operating system of the device is loaded and operating normally. Many of these devices may operate on battery power and there is an increasing demand for longer and more robust battery performance.

### BRIEF DESCRIPTION OF THE DRAWINGS

The following detailed description references the drawings, wherein:

FIG. 1 is a block diagram of an example device to change power states.

FIG. 2 is a block diagram of an example device including possible additional example components of the device of FIG. 1.

FIG. 3 is a flowchart of an example method for changing power states.

FIG. 4 is a flowchart of an example method for changing power states which may be incorporated into the flowchart of FIG. 3.

FIG. 5 is a flowchart of an example method for changing power states which may be incorporated into the flowchart of FIG. 3.

FIG. 6 is a flowchart of an example method for changing power states which may be incorporated into the flowchart of FIG. 3.

FIG. 7 is an example of a system to change power states of a device.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

As used herein, a “device” refers to any electrical device which operates using an operating system that is loaded onto the electronic device, such as, a personal computer (PC), a notebook computer, a tablet computer, a mobile phone, a smart device (e.g., smartwatch), etc. An operating system (OS) may be a program to manage resources, such as hardware and other programs, in an electronic device. To protect the OS from failure and increase battery performance, devices have various conditions which may trigger the pausing, stopping, and closing of the OS, such as power states. A device may support multiple power states to manage power consumption in which the OS may or may not be operational.

Power states may be defined according to various standards for various devices. For example, power states of devices using an OS may be defined by the Advanced Configuration and Power Interface (ACPI) specification. Among supported power states for devices using an OS may be a working power state (S0) and intermediate power states (S1-S3), such as a standby state or a sleep state, in which the OS is operational. As used herein, a “full power” state refers to any power state of a device in which an OS is operational and power is provided to keep the content of volatile memory refreshed to maintain a system state. As used herein, “volatile memory” refers to forms of processor-readable memory which use constant power in order to prevent data from being erased. In contrast, “non-volatile memory” refers to forms of processor-readable memory that can retrieve stored information even after having been power cycled (i.e., turned off and back on). In examples, in a full power state, the device is either working under normal conditions or may be soft booted to a working condition.

Other supported power states of devices may include a hibernate state (S4), a soft off state (S5), and a mechanical off state (G3) in which the OS is not operational and power may not be provided to volatile memory. As used herein, to “boot” a device refers to the initialization of the device until an OS of the device is loaded. As used herein, an “ultra-low” power state refers to a power state in which an OS is not operational and in which power is being provided to a component of the device other than volatile memory. In examples, to resume normal operation of a device from such an ultra-low power state an OS of the device may be hard booted. In examples, an ultra-low power state may include a hibernate (S4) state and a soft off (S5) state. A “hard boot” refers to a booting process in which a power-on self-test (POST) is conducted of hardware in and coupled to the device. In contrast, a “soft boot” refers to a booting process in which POST is avoided, for example, after exiting a sleep state.

The ability to wake from an ultra-low power state (e.g., hibernate (S4) or soft off (S5)) using a peripheral device, such as a mouse or a keyboard, coupled to the device may be useful. In examples, peripheral devices may be any of a number of human interface devices coupled via a Universal Serial Bus (USB) connection. As used herein, a USB connection may refer to a connection between devices operating under the parameters of the universal serial bus standard, FireWire® standard, or other standards for communication and power supply between devices. In examples, a device may include an input/output (I/O) port through which to couple to a USB device. A number of devices may provide power to detect an actuation event received via a peripheral device in some full power states, such as sleep or standby states (S1-S3), and some ultra-low power states, such as a hibernate state (S4). In such examples, the device may provide power to I/O ports in these states to monitor for and/or detect an actuation event. In an example, signals representing machine-executable instructions to change a power state may be transmitted to a device from a component coupled thereto. The signals may be received by an OS of the device, such as Windows or OSX for computing devices. The signals may cause the OS of the device to determine whether a component may be used to change a power state of the device. There may be a desire, however, to have a change in power state or a wake operation be performed other than by an OS of a device, such as to protect the OS from unnecessary actuation or to preserve power, such as battery power, by unnecessarily booting the OS. In addition, there may be a desire to wake from a specific peripheral device from all ultra-low power states. For example, a user may desire to wake from an ultra-lower power state via a particularly identified keyboard rather than a mouse coupled thereto.

To address these issues, in examples, identifying and handling of an actuation event received by a component coupled to a device may be handled by an executable program loaded from non-volatile memory of the device and executed by a processor of the device to provide an interface between an OS of the device and the hardware and/or programs of the device. In the context of a computing device, for example, the interface program may comprise a Basic Input/Output System (BIOS) which may be loaded by a chipset processor from non-volatile memory of the computing device. The BIOS may enable hardware component testing and verification (e.g., POST) and may facilitate loading of a primary OS from a device memory. Thus, in a computing context, a sample BIOS may refer to a BIOS of a PC, another example BIOS may refer to an Extensible Firmware Interface (EFI) of a device, such as an EFI of a Mac® computer by Apple® Inc. or an IBM®-compatible PC, another example BIOS may refer to a Unified Extensible Firmware Interface (UEFI) of a PC, and like interfaces to be developed in the future. At times, a BIOS may be alternatively referred to as a bootloader. For example, Raspberry Pi® may use a graphics processing unit (GPU)—based bootloader as a BIOS, and Android® devices, iOS® devices, and Tizen® devices may also use a bootloader. For simplicity, all such executable programs loaded from non-volatile memory and providing an interface between an OS and hardware and/or other programs are referred to as a BIOS. It should therefore be apparent that a BIOS may be used in a number of devices including and/or present in electronic devices, appliances, printing devices, and digital assistants, by way of non-limiting example.

As used herein, the term “actuation event” refers to a signal received from a component to indicate a physical interaction with the component, for example by a user, to attempt to wake a device. In examples, the type of physical interaction which constitutes an actuation event may vary according to the type of component. For example, an actuation event may occur when a mouse is moved. In another example, an actuation event may occur when a specific key(s) is pressed on a keyboard. As used herein, the term “wake” or “wake operation” refers to an operation(s) to restore a device to any of the full power states. In other words, a wake operation may change a power state of a device to any of the full power states, such as, a working state (S0) or intermediate power states (S1-S3). For example, a wake operation may change a power state from a soft off state (S5) to a working state (S0) or intermediate power states (S1-S3). In another example, a wake operation may change a power state from an intermediate power state (S3) to a working state (S0). In examples, a device may be hard booted to wake from an ultra-low power state. In other examples, a device may be soft booted to wake from a full power state (e.g., sleep state). In an example, changing power states (e.g., waking) of a device according to an actuation event received by a component may be performed in response to installation of an updated BIOS on the device. In such an example, executable instructions for an updated BIOS may include a list of reference identifications (IDs). For example, the updated BIOS executable instructions may also include instructions for an update of POST in the BIOS.

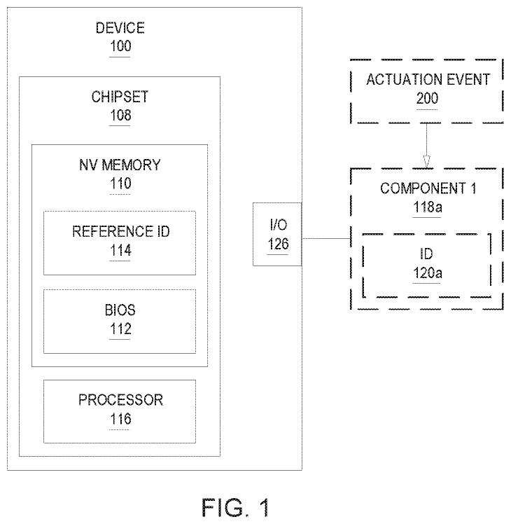

Referring now to the drawings, FIG. 1 is a block diagram of a device 100 to change power states. Device 100 may be, for instance, a computing device. In another example, device 100 may form an element of a subsystem of a system. For instance, a printing device may include of a number of subsystems. Among other things, the printing device may include a number of computing systems (e.g., a system to perform print operation, a system to monitor print performance, a system to perform a scan or copy function, a system to display printing device statuses, etc.). Device 100 may be an element in one or more of the systems or subsystems of the printing device. Device 100 may include a chipset 108, a non-volatile (NV) memory 110, reference identification (ID) 114, BIOS 112, processor 116, and I/O port 126. Furthermore, device 100 may be coupled to a component 1 118a with a component ID 120a. Component 1 118a, component ID 120a, and actuation event 200 in FIG. 1 are illustrated in dashed lines to indicate that component 1 118a, component ID 120a, and actuation event may be included in some examples, while other examples may not include component 1 118a, component ID 120a, and actuation event 200. In examples, the term “couple” or “couples” is intended to include suitable indirect and/or direct connections. Thus, if a first component is described as being coupled to a second component, that coupling may, for example, be: (1) through a direct electrical or mechanical connection, (2) through an indirect electrical or mechanical connection via other devices and connections, (3) through an optical electrical connection, (4) through a wireless electrical connection; (5) a communicative connection, and/or (6) another suitable coupling. In contrast, the term “connect” or “connects” is intended to include direct mechanical and/or electrical connections.

Example chipset 108 may be a set of electrical components, such as processors (e.g., processor 116) including ASICs, memory (e.g., NV memory 110), etc. to manage transfer of signals between other components of device 100, for example, additional processors (not shown in FIG. 1), additional memories (not shown in FIG. 1), and component 1 118a. Chipset 108 may be used in an example to identify and handle power changes, as shall be described hereinafter.

In the example of FIG. 1, chipset 108 may include NV memory 110 in which may be stored executable instructions, such as executable instructions for BIOS 112, which may be executed by processor 116. In examples, processor 116 may be referred to as a chipset processor. As used herein, “processor” may be at least one of a central processing unit (CPU), a semiconductor-based microprocessor, an application-specific integrated circuit (ASIC), a GPU, a field-programmable gate array (FPGA) to retrieve and execute instructions, other electronic circuitry suitable, such as transistors, for the retrieval and execution of instructions stored on a machine-readable storage medium, or a combination thereof. A processor may fetch, decode, and execute instructions stored on a memory to perform the functionalities described below. In other examples, the functionalities of any of the instructions of a memory may be implemented in the form of electronic circuitry, in the form of executable instructions encoded on a machine-readable storage medium, such as non-transitory machine-readable storage medium, or a combination thereof.

In examples, reference ID 114 may also be stored in NV memory 110. As used herein, “reference ID” refers to an identification, such as a product ID and/or a vendor ID, of a component approved to wake a device from an ultra-low power state. In examples, reference ID 114 may be a single component's ID or multiple components' IDs. In examples, reference ID 114 may be included within executable instructions for BIOS 112.

In examples, chipset processor 116 may communicate with component 1 118a coupled to device 100. In examples, component 1 118a may be any type of a human interface device (HID). In examples, a HID may include a touch screen, a mouse, a keyboard, a joystick, etc. In examples, component 1 118a may be coupled to device 100 via a USB connection. In examples, device 100 may provide power to monitor for and/or detect an actuation event 200 received by component 1 118a in an ultra-low power power in ultra-low power states to monitor for and/or detect actuation event 200. In examples, device 100 may provide signals indicative of actuation event 200 received by component 1 118a to processor 116. In such an example, I/O port 126 of device 100 may provide signals indicative of actuation event 200 received by component 1 118a to processor 116.

In the example of FIG. 1, device 100 may include I/O port 126, which may provide an interface to a component, such as component 1 118a. It is noted that I/O port 126 may be composed of a plurality of different components and is illustrated by a single element for simplicity. Device 100 may provide power to I/O port 126 in an ultra-low power state to monitor or detect actuation event 200 at component 1 118a. In examples, I/O port 126 may provide signals indicative of actuation event 200 to processor 116 in an ultra-low power state. In another example, I/O port 126 may communicate with another processor of device 100 (not shown) in a full power state to communicate signals received by component 1 118a for the operation of device 100.

In examples, in response to reception of signals indicative of actuation event 200 at component 1 118a, processor 116 may determine a component ID 120a. In examples, a “component ID” refers to an identification, such as a product ID and/or a vendor ID, of a component of a device. In an example, BIOS 112 may be capable of identifying an ID 120a of component 1 118a. In an example, a component ID of a component may be hard-coded into the component, such as at a time of manufacture. Thus, BIOS 112 may be capable of transmitting a request for a component ID, such as to component 1 118a, and in response a component ID may be transmitted to BIOS 112. In another example, upon installation of component 1 118a in device 100, information relating to component 1 118a (e.g., a component ID 120a) may be stored in a memory, such as NV memory 110 or another memory, by way of non-limiting example. In examples, processor 116 may determine a component ID 120a of component 118a during POST. In other examples, processor 116 may determine a component ID 120a of component 118a after POST. In examples, processor 116 may fetch a reference ID 114 from NV memory 110 and compare reference ID 114 to component ID 120a. In examples_{;} an updated BIOS executable instructions may also include instructions for an update of POST in the BIOS. In examples, the updated BIOS may include instructions to alter BIOS (e.g., a POST) to determine component IDs and compare component IDs to reference ID.

In an example, there may be a match between the determined component ID 120a and reference ID 114. As used herein, the term “match” refers to a close similarity, connection, or equivalence between two items. For example, determined component ID 120a and reference ID 114 may match in whole or in part. For example, if an entire group of components are approved to wake device 100 and have component IDs that span a series of consecutive IDs (e,g., xxxx00-xxxx99), then a portion of the determined component ID may correspond to a common string of characters from the reference IDs (e.g., xxxx15). In such an example, processor 116 may transmit a signal to change a power state of device 100. For example, processor 116 may transmit a signal to wake device 100 from an ultra-low power state to a full power state, In such an example, processor 116 may begin a hard boot process to change powerstates. In such examples, processor 116 may load a primary OS (not shown in FIG. 1) of device 100 as described in more detail below.

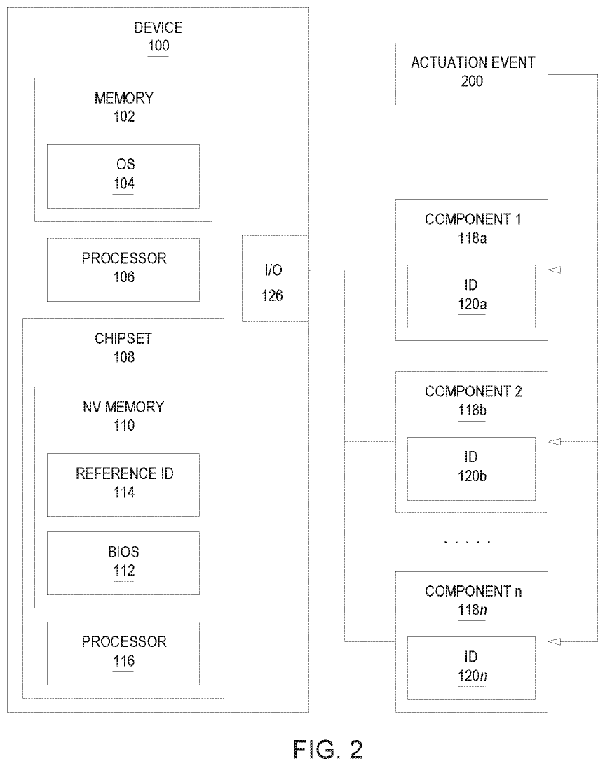

FIG. 2 is a block diagram of an example device including possible additional example components of device 100 of FIG. 1. Additional components may include memory 102, operating system (OS) 104, processor 106, and components 118b-118n, and are described herein with reference to the description of FIG. 1.

In an example, memory 102 may be forms of processor-readable memory such as random access memory (RAM), read-only memory (ROM), non-volatile memory (NV memory), flash memory, resistive memory (e.g., phase change memory), hard disk drive memory, solid state memory, and optical memory (e.g., digital versatile disc (DVD)), by way of illustration. Memory 102 may enable storage and retrieval of data (e.g., signals or states, such as stored as binary ‘1’s and ‘0’s in a binary digital implementation). Memory 102 may be in communication (e.g., electrical communication) with processor 106 via a bus, such as an electrical bus. In an example, a bus connecting memory 102 and processor 106 may also enable communication between other components of device 100. For example, processor 106 may be capable of communicating (e.g., exchanging signals) with chipset 108 and components 118a-118n via the bus.

In examples, OS 104 be a primary OS of device 100. In examples, OS 104 may be stored as executable instructions within memory 102 and may be executed by processor 106. In an example, device 100 may use a plurality of operating systems in order to control and manage exchange of signals between components of device 100. In an example, a first OS may be a program operating at a low level in a software stack. In some examples, BIOS 112 may be a portion of the first OS. In other examples, BIOS 112 may operate in conjunction with the first OS. In examples, a program operating at a low level in a software stack may coordinate signal exchange between hardware components, programs, etc., but not necessarily be an application layer executable instruction. The first OS may be started in response to execution of executable code stored in NV memory 110. In such an example, a second OS, referred to herein alternatively as a “primary” OS 104, may enable coordination of signal exchange between hardware components, programs, the first OS, and/or applications operating at the application layer of the software stack. OS 104 may comprise a Unix®-based OS, a Linux®-based OS, a Windows®-based OS, an OSX-based OS, a mobile device OS (e.g., an iOS®-based OS, an Android®-based OS, etc.), and a QNX®-based OS, by way of non-limiting example. Executable instructions, such as for an OS or a BIOS, may be executed by a processor. Processor 106 may be an example processor capable of interpreting and executing instructions. Processor 116 may be another example processor capable of interpreting and executing instructions. In an example, processor 116 may be capable of providing support for processor 106 and/or OS 104. For example, processor 116 may initialize OS 104 and processor 106 of device 100.

Components 118b-118n may be any type of HID as described above with respect to component 1 118a. In examples, components 118a-118n may be coupled to device 100 via a USB connection. In the example of FIG. 2, actuation event 200 may be received by any of components 118a-118n. In some examples, actuation event 200 may be received by a plurality of components 118a-118n. In response to reception of signals indicative of actuation event 200 at components 118a-118n, processor 116 may determine component IDs 120a-120n for any of components 118a-118n which received an actuation event. In an example, BIOS 112 may be capable of identifying an ID 120a of component 1 118a, an ID 120b of component 2 118b, and an ID 120n of component n 118n. In an example, a component ID of a device may be hard-coded into the component, such as at a time of manufacture. Thus, BIOS 112 may be capable of transmitting a request for a component ID, such as to components 118a-118n, and in response a component ID may be transmitted to BIOS 112. In another example, upon installation of components 118a-118n in device 100, information relating to components 118a-118n (e.g., a component ID) may be stored in a memory, such as memory 102, NV memory 110, or another memory, by way of non-limiting example.

In the example of FIG. 2, device 100 may include I/O port 126, which may provide an interface to peripheral devices, such as components 118a-118n. It is noted that I/O port 126 may be composed of a plurality of different components and is illustrated by a single element for simplicity. In the example of FIG. 2, device 100 may provide power to I/O port 126 in an ultra-low power state to monitor for and/or detect actuation event 200 at components 118a-118n. In examples, I/O port 126 may provide signals indicative of actuation event 200 to processor 116 in an ultra-low power state. In another example, I/O port 126 may communicate with processor 106 in a full power state to communicate signals received by components 118a-118n for the operation of device 100.

In operation, device 100 may be in an ultra-low power state, such as a soft off state or hibernate state. In such an example, device 100 may provide power to I/O port 126 to monitor components 118a-118n coupled to device 100. In the example of FIG. 2, actuation event 200 may be received by components 118a-118n, In examples, I/O port 126 may provide signals indicative of actuation event 200 to processor 116. In response to reception of signals indicative of actuation event 200 at components 118a-118n, processor 116 may determine component IDs 120a-120n for any of components 118a-118n which received actuation event 200. Processor 116 may, in such an example, compare component IDs 120a-120n for any of components 118a-118n which received actuation event 200 with reference ID 114. In examples, processor 116 may transmit a signal to change the power state of device 100 in response to a match between component IDs 120a-120n and reference ID 114. In such an example, processor 116 may transmit signals to other components of device 100, such as a battery, to wake device 100. In such examples, processor 116 may begin a hard boot process of device 100 using BIOS 112 which may include instructions to transmit signals to other components of device 100. For example, BIOS 112 may include instructions to transmit signals to a switch of a power source (e.g., battery) to begin providing power to additional components of device 100. In other examples, processor 116 may maintain a power state of device 100 in response to a lack of match between component IDs 120a-120n and reference ID 114. In such examples, processor 116 may terminate a wake process in response to a lack of match between component IDs 120a-120n and reference ID 114. In such an example, processor 116 may terminate a wake process before OS 104, processor 106, or both are initialized. In other words, processor 116 may cause device 100 to disregard actuation event 200 when the component which received actuation event is not an approved component to wake device 100 and thereby maintain the power state of device 100.

In examples, the use of a chipset processor (processor 116) to compare a component ID with a reference ID may result in disregarding actuation events from non-approved components. In such examples, the disregarding of actuation events before loading of the primary OS may prevent loading of the primary OS (OS 104) and associated components (processor 106). In such examples, reducing loading of the primary OS to identify and handle approval of actuation events may improve power management and protect the primary OS (OS 104) from failure.

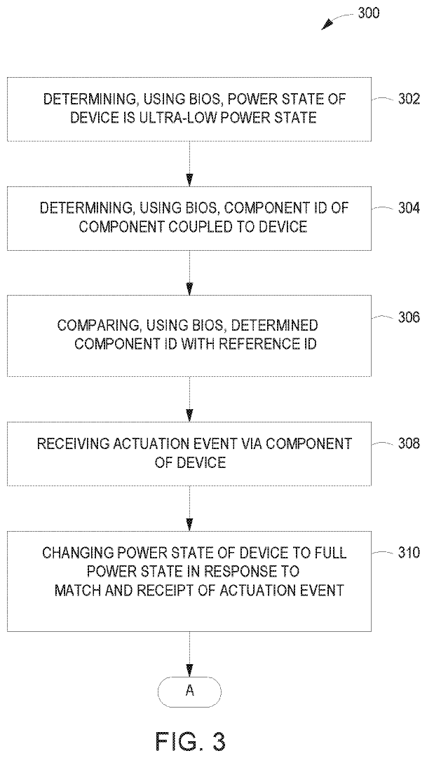

FIG. 3 is a flowchart of an example method for changing power states. Although execution of method 300 is described below with reference to device 100 of FIGS. 1-2 described above, other suitable systems for the execution of method 300 can be utilized. Additionally, implementation of method 300 is not limited to such examples.

At 302 of method 300, device 100 may determine, using BIOS 112, whether a power state of device 100 is an ultra-low power state. In examples, processor 116 may execute instructions to provide a BIOS, which may provide an interface between primary OS 104 and other programs and/or hardware of device 100. For example, referring back to FIG. 1, executable instructions may be stored in NV memory 110 and may be executed by processor 116 to provide a BIOS 112. In examples, processor 116 may determine a power state of device 100 is an ultra-low power state.

At 304, device 100 may determine, using BIOS 112, a component ID of a component coupled to device 100. In examples, the component may be a HID coupled to the device. In examples, BIOS 112 may be capable of determining a component ID for a component of the device. Referring back to FIG. 2, for example, BIOS 112 may be capable of identifying an ID 120a of component 1 118a, an ID 120b of component 2 118b, and an ID 120n of component n 118n. In an example, a component ID of a component may be hard-coded into the component, such as at a time of manufacture. Thus, BIOS 112 may be capable of transmitting a request for a component ID, such as to components 118a-118n, and in response a component ID may be transmitted to BIOS 112. In another example, upon installation of components 118a-118n in device 100, information relating to components 118a-118n (e.g., a component ID) may be stored in a memory, such as memory 102, NV memory 110, or another memory, by way of non-limiting example.

At 306, device 100 may compare using BIOS the determined component ID with a reference ID. In example device 100, BIOS 112 may be able to fetch reference ID 114 which may be stored in a memory, such as NV memory 110. For example, reference ID 114 may be stored on NV memory 110 upon installation of BIOS 112 or installation of an update of BIOS 112. In example device 100, processor 116 may determine if component IDs 120a-120n and reference ID 114 match in whole or in part. For example, if an entire group of components are approved to wake a device and have component IDs that span a series of consecutive IDs (e.g., xxxx00-xxxx99), then a portion of the determined component ID may correspond to a common string of characters from the plurality of recall IDs (e.g., xxxx15).

At 308, device 100 may receive actuation event 200 via the component coupled to the device. In examples, components 118a-118n may be coupled to device 100 to receive actuation event 200. In examples, any of components 118a-118n may receive actuation event 200. In example device 100, I/O port 126 may transmit signals indicative of actuation event 200 to processor 116.

At 310, device 100 may change the power state of device 100 to a full power state in response to a match between the determined component ID and the reference ID and in response to the receipt of the actuation event. In response to a match between component ID 120a-120n and reference ID 114 and in response to the receipt of actuation event 200, processor 116 may transmit signals to change the power state of device 100. In such examples, processor 116 may transmit signals to change the powerstate from an ultra-low power state (e.g., S4 or S5) to a full power state (e.g., S0-53). In such an example, processor 116 may transmit signals to a switch of a power source (e.g., battery) to begin providing power to additional components in device 100.

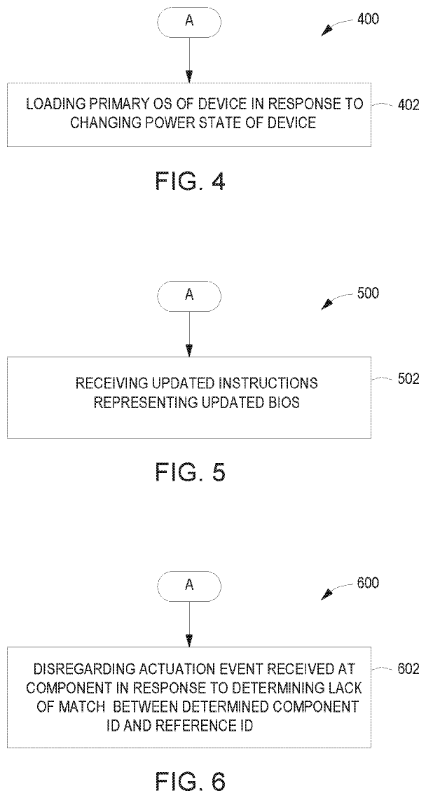

FIGS. 4-6 are flowcharts of example methods for changing power states which may be incorporated into the flowchart of FIG. 3 at A. Although execution of the methods of FIGS. 4-6 is described below with reference to device 100 of FIG. 2 and the flowchart of FIG. 3 described above, other suitable systems for the execution of the methods of FIGS. 4-6 can be utilized. Additionally, implementation of the methods of FIGS. 4-6 are not limited to such examples.

At 402 of method 400, device 100 may load a primary OS in response to changing a power state. In examples, the primary OS may be OS 104. In such an example, processor 116 may initiate a wake process or booting to load primary OS 104 using BIOS 112.

At 502 of method 500, device 100 may receive updated instructions representing an updated BIOS. In examples, the updated BIOS may include instructions to alter BIOS to determine component IDs and compare component IDs to a reference ID.

At 602 of method 600, device 100 may disregard actuation event 200 received at components 118a-118n in response to determining a lack of match between determined component IDs 120a-120n and reference ID 114. In examples, processor 116 may maintain a power state of device 100 in response to a lack of match between component IDs 120a-120n and reference ID 114. In such examples, processor 116 may terminate a wake process in response to a lack of match between component IDs 120a-120n and reference ID 114. In other words, processor 116 may cause device 100 to disregard actuation event 200 when the component which received the actuation event is not an approved component to wake device 100.

Although the flowcharts of FIGS. 3-6 shows a specific order of performance of certain functionalities, the flowcharts of FIGS. 3-6 are not limited to that order. For example, the functionalities shown in succession in a flowchart may be performed in a different order, may be executed concurrently or with partial concurrence, or a combination thereof. In some examples, functionalities described herein in relation to FIGS. 3-6 may be provided in combination with functionalities described herein in relation to any of FIGS. 1-2 and 7.

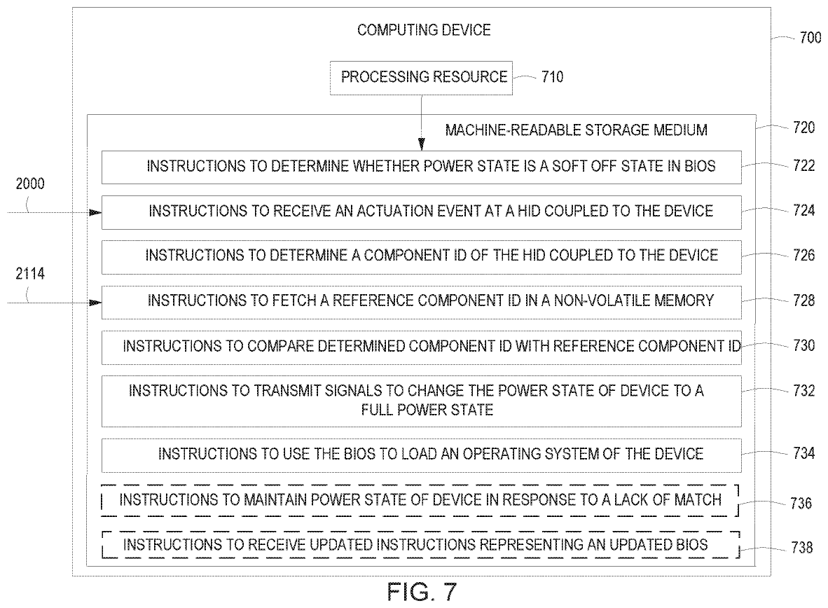

FIG, 7 is an example of a system to change power states of a device. In the example of FIG. 7, computing device 700 includes a processing resource 710 and a machine-readable storage medium 720 comprising (e.g., encoded with) instructions 722, 724, 726, 728, 730, 732, 734, 736, and 738 executable by processing resource 710. In some examples, storage medium 720 may include additional instructions. In some examples, instructions 722, 724, 726, 728, 730, 732, 734, 736, and 738 may be instructions of a computer program, computer application (“app”), agent, or the like, of device 100 of FIGS. 1 and 2. In other examples, the functionalities described herein in relation to instructions 722, 724, 726, 728, 730, 732, 734, 736, and 738 may be implemented as engines comprising any combination of hardware and programming to implement the functionalities of the engines, as described below. In the example of FIG. 7, instructions 736 and 738 are shown in dashed lines to indicate that instructions 736 and 738 may be included in some examples, while other examples may not include instructions 736 and 738.

In examples described herein, a processing resource may include, for example, one processor or multiple processors included in a single computing device (as shown in FIG. 7) or distributed across multiple computing devices. Processing resource 710 may fetch, decode, and execute instructions stored on storage medium 720 to perform the functionalities described below. In other examples, the functionalities of any of the instructions of storage medium 720 may be implemented in the form of electronic circuitry, in the form of executable instructions encoded on a machine-readable storage medium, or a combination thereof. In examples, storage medium 720 may be a non-volatile memory.

In the example of FIG. 7, instruction 722 may determine whether device 700 is in a soft off state in a BIOS of device 700. In examples, referring to device 100, processor 116 may execute instructions to provide BIOS 112, which may provide an interface between primary OS 104 and other programs and/or hardware of device 100. For example, referring back to FIG, 1, executable instructions may be stored in NV memory 110 and may be executed by processor 116 in order to provide BIOS 112. In examples, processor 116 may determine a power state of device 100 is a soft off state.

Instruction 724 may receive an actuation event 2000 at a HID coupled to device 700. In examples, referring to device 100, components 118a-118n may be coupled to device 100 to receive an actuation event. In such examples, any of components 118a-118n may receive the actuation event. In such an example, I/O port 126 may transmit signals indicative of actuation event 200 to processor 116.

Instruction 726 may determine a component ID of the HID coupled to device 700. In examples, referring to device 100, BIOS 112 may be capable of determining a component ID for a HID. Referring back to FIG. 2, for example, BIOS 112 may be capable of identifying an ID 120a of component 1 118a, an ID 120b of component 2 118b, and an ID 120n of component n 118n. In such an example, a component ID of a HID may be hard-coded into the HID, such as at a time of manufacture. Thus, BIOS 112 may be capable of transmitting a request for a component ID, such as to components 118a-118n, and in response a component ID may be transmitted to BIOS 112. In another example, upon installation of components 118a-118n in device 100, information relating to components 118a-118n (e.g., a component ID) may be stored in a memory, such as memory 102, NV memory 110, or another memory, by way of non-limiting example.

Instruction 728 may fetch a reference ID 2114 in a non-volatile memory of device 700. In example device 100, BIOS 112 may be able to fetch reference ID 114 which may be stored in a memory, such as NV memory 110. For example, reference ID 114 may be stored on NV memory 110 upon installation of BIOS 112 or installation of an update of BIOS 112.

Instruction 730 may compare the determined component ID with the reference ID. In example device 100, processor 116 may determine if component IDs 120a-120n and a reference ID 114 match in whole or in part. For example, if an entire group of components are approved to wake a device and have component IDs that span a series of consecutive IDs (e.g., xxxx00-xxxx99), then a portion of the determined component ID may correspond to a common string of characters from the plurality of recall IDs (e.g., xxxx15).

Instruction 732 may, in response to a match between the determined component ID and the reference ID 2114, transmit signals to change the power state of device 700 to a full power state. In such examples, processor resource 710 may transmit signals to being a wake process from a soft off state to a full power state in response to the match between the determined component IDs and reference ID 2114. In examples, referring to device 100, processor 116 may transmit signals to change the power state to a full power state from a soft off state. In such an example, referring to device 100, processor 116 may transmit signals according to instructions in BIOS 112 to change the power state to the full power state.

Instruction 734 may, in response to changing the power state of the device, use the BIOS to load an operating system of the device. In example device 100, processor 116 may initiate a booting process to load primary OS 104 using BIOS 112.

Instruction 736 may, in response to a lack of match between the determined component ID and the reference ID 2114, maintain a power state of device 700 when an actuation event 2000 is received at the HID. In such examples, processor resource 710 may terminate a wake process in response to a lack of match between component IDs and reference ID 2114. In such an example, device 700 may remain in a soft off power state.

Instruction 738 may receive updated instructions representing an updated BIOS. In examples, the updated BIOS may include instructions to alter BIOS to determine component IDs and compare component IDs to reference ID 2114.

All of the features disclosed in this specification (including any accompanying claims, abstract and drawings), and/or all of the steps of any method or process so disclosed, may be combined in any combination, except combinations where at least some of such features and/or steps are mutually exclusive.

1. A device comprising:
an input/output port to couple to a component to receive an actuation event; and
a chipset processor to:
determine a power state of the device;
in response to a determination that the power state is an ultra-low power state, determine a component identification (ID) of the component;
fetch a reference ID from non-volatile memory;
compare the determined component ID with the reference ID; and
transmit a signal to change the power state of the device in response to a match between the determined component ID and the reference ID and reception of signals indicative of an actuation event.

2. The device of claim 1, wherein the chipset processor is to load an operating system (OS) of the device in response to changing the power state of the device.

3. The device of claim 1, wherein the component ID corresponds to an ID of a human interface device (HID) coupled to the device.

4. The device of claim 3, wherein the HID is coupled to the device via a Universal Serial Bus (USB) connection.

5. The device of claim 1, wherein the chipset processor is to, in response to a lack of a match between the determined component ID and the reference ID, to maintain a power state of the device when an actuation event is received at the component.

6. A method for changing power states, comprising:
determining, using a Basic Input/Output System (BIOS) of a device, a power state of the device is an ultra-low power state;
determining, using the BIOS, a component identification (ID) of a component coupled to the device;
comparing, using the BIOS, the determined component ID with a reference ID;
receiving an actuation event via the component coupled to the device; and
changing the power state of the device to a full power state in response to a match between the determined component ID and the reference ID and in response to the receipt of the actuation event.

7. The method of claim 6, further comprising loading a primary operating system (OS) of the device in response to changing the power state of the device.

8. The method of claim 6, wherein the reference ID is stored in a non-volatile memory.

9. The method of claim 6, wherein the component ID corresponds to an ID of a human interface device (HID) coupled to the device.

10. The method of claim 6, further comprising receiving updated instructions representing an updated BIOS.

11. The method of claim 6, further comprising disregarding an actuation event received at the component in response to determining a lack of match between the determined component ID and the reference ID.

12. A non-transitory computer-readable medium, comprising instructions that when executed cause a processor of a device to:
determine whether the device is in a soft off state in a Basic Input/Output System (BIOS) of the device;
receive an actuation event at a human interface device (HID) coupled to the device;
determine a component identification (ID) of the HID coupled to the device;
fetch a reference ID in a non-volatile memory of the device;
compare the determined component ID with the reference ID;
in response to a match between the determined component ID and the reference ID, transmit signals to the processor to change the power state of the device to a full power state; and
in response to changing the power state of the device, use the BIOS to load an operating system of the device.

13. The medium of claim 12, wherein the HID is coupled to the device via a Universal Serial Bus (USB) connection.

14. The medium of claim 12, wherein the instructions when executed further cause the processor to, in response to a lack of match between the determined component ID and the reference ID, to maintain a power state of the device when an actuation event is received at the HID.

15. The medium of claim 12, wherein the instructions when executed further cause the processor to receive updated instructions representing an updated BIOS.
